(19) United States
(12) Patent Application Publication
(10) Pub. No.: US 2013/0026251 A1
(43) Pub. Date: Jan. 31, 2013

(54) Strip mine conveyor belt dust control

(71) Applicant: Peter Cordani, Palm Beach Gardens, FL (US)

(72) Inventor: Peter Cordani, Palm Beach Gardens, FL (US)

(21) Appl. No.: 13/560,363

(22) Filed: Jul. 27, 2012

Related U.S. Application Data
(60) Provisional application No. 61/513,410, filed on Jul. 29, 2011.

(51) Int. Cl. B05B 7/26

(52) U.S. Cl. 239/310

(57) ABSTRACT

The invention is directed to the control of dust raised around strip mining conveyor belt operations. The system includes a tank for storage of an aqueous solution of a potassium based super absorbent swellable polymer and water at a rate of about 0.75 lbs per 100 gallons of water. A distribution system includes a pressure pump and directing the aqueous solution through an inline mixer capable of shearing the solution for directional placement through a pin hole spray nozzle. The system includes a recirculation system that maintains the aqueous solution in suspension when the solution is not being distributed.

### RELATED REFERENCE

This invention is related to U.S. patent application Ser. No. 13/345,234 entitled System and Method of Controlling Dust about Strip Mines, filed Jan. 6, 2012, the contents of which is incorporated herein by reference.

### FIELD OF THE INVENTION

The invention is directed to control dust, and in particular, to a system and method of controlling dust raised around strip mining operations.

### BACKGROUND OF THE INVENTION

Strip mining is an effective procedure to recover rock, stone, gravel, slag, or other valuable resources. Strip mining, also known as surface mining, typically employs the use of earth movers for removal of an overlying soil deposit to expose the useful minerals beneath. Drag mine excavators and/or bucket wheel excavators are then used to extract minerals, the amount of which is only limited by the size of the mineral bed underlying. It is not unusual for a surface mine to dig hundreds of feet into the earth or extend for miles in length.

When strip mining, the underlying minerals must be transported within the mine site for efficient processing. With the efficiency of modern digging equipment, tons upon tons of mineral can be quickly excavated. The excavated material is transported from the excavation point to a central processing location by truck. The excavated material is then loaded onto conveyor belts as the excavated material is moved towards the crushing, grinding or pulverizing of that excavated material. The moving of the materials along the conveyor belt results in problematic dust.

A problem with strip mining to which this invention addresses is the control of airborne fugitive dust residing from excavated material and distributed by use of fast moving conveyor belts. Of particular interest to the current invention includes the strip mining process of moving the excavated material. Dust is known to saturate the strip mine and surrounding area with unhealthy airborne particulates. The particulate matter can cause a degradation of ambient air quality of the encompassing areas. That particulate matter may be a source for adverse health effects through respirable exposure, putting the workers and the public at risk for pneumoconiosis, progressive massive fibrosis, silicosis, and chronic obstructive pulmonary disease. If the strip mine is subjected to any wind, the dust can be transported very quickly to surrounding areas where it can be offensive to the neighboring community.

Furthermore, the dust can damage, if not destroy, the conveyor belt machinery and surrounding equipment. It is well known that dirt and dust indigestion into roller bearings supporting the conveyor belt can result in premature wear leading to costly maintenance or replacement.

Dust damage is not limited to the conveyor belt machinery, the operators are also susceptible to inhalation of dust. It has been found that inhaling of dust can lead to asthma and in instances of coal mining, chronic problems such as black lung disease. Depending where the strip mine is located, the dust can be transported over a large distances and affect neighboring communities. Unlike the machinery located in a strip mine which includes specialty equipment for handling of airborne dirt, the cars, trucks, boats, motorcycles, planes, lawn moving equipment and the like found in the neighboring communities do not include the specialty filters found at the strip mines. Further, while the operators of the mine equipment are cognoscente of the problems that can be caused by dust and may even wear appropriate respiratory equipment, the average consumer in a surrounding town may not understand the damage that airborne dust is having on them, or cannot afford to purchase the appropriate respiratory equipment.

The control of dust is of such a concern both in damage to health and machinery, most every mine operation includes methods that attempt to control the dust. In particular, a basic yet productive method of controlling dust is by use of a wet dust suppression system that coats the excavated material with water droplets causing the suppression of dust by the weight of the water. Nonetheless, a wet dust suppression system does not solve the instant problem because water evaporation leaves the dust particulate capable of becoming airborne.

Dust suppression, control and methods thereof that utilize a polymer or a copolymer to reduce water evaporation are known in the art. U.S. Pat. No. 4,417,992 discloses a dust control composition and method. The dust is controlled by applying an inhibiting amount of a liquid dispersion of watery consistency of highly branched water swellable polymer of acrylamide or an acrylamide-acrylic acid copolymer.

U.S. Publication No. 2009/0090890 discloses a composition useful for the suppression of fugitive dust emissions and methods of suppressing dust emissions by application of an aqueous solution comprising a surfactant, wetting agent and an acrylic copolymer capable of penetrating and improving particle cohesion and reducing water evaporation, as well as a knockdown agent for airborne dust.

What is needed in the art is a method of controlling dust in a strip mine employing a conveyor belt for movement of material and, in particular, a system for delivering a fine polymer that does not gel when admixed with water.

### SUMMARY OF THE INVENTION

The present invention is directed to a potassium based polymer dust control system for use at strip mines, rock quarries and mining operations of all types, processing of excavated material and general excavation work. In particular, the invention is based upon the application of a fine absorbent polymer in combination with water to excavated material of the strip mine. The absorbent polymer is premixed with water and is applied to the excavated materials by use of a water dispersion system. The absorbent polymer provides water retention and can be re-hydrated by rain, dew, or additional water.

In accordance with an aspect of the present invention there is provided a dust control system and method of dispersing a composition formed from a non-corrosive, nonflammable, non-toxic, ecologically safe aqueous solution. The composition being formed of a potassium based polymer consisting of a filter polymer powder that is admixed into an aqueous solution. The aqueous solution is capable of being pushed through a hole less than 1 mm by 1 mm.

The absorbent polymer can absorb and store many times its own weight in water. Properly applied, the absorbent polymer will reduce the amount of water lost through percolation, evaporation and runoff thereby reducing the amount of water necessary to treat a given area.

An objective of the instant invention is to disclose a dispersion system for control of dust along strip mine conveyor belts by use of a spray line for dispersing an aqueous solution of water and potassium based polymer over material carried by the conveyor belts.

Another objective of the instant invention is to reduce the amount of water employed in the control of dust and lessen the need for recapture of material that otherwise drifts from the conveyor belt.

It is a further objective of the instant invention to include a pump to disperse the aqueous solution at a controlled pressure and flow rate to provide inline mixing of the aqueous solution by use of a static mixer and include a misting tip.

Another objective of the instant invention is to provide an improved method of treating excavated material, the method including a polymer having anti-caking characteristics that allow it to be dispersed using conventional water distribution means.

Still another objective of the instant invention is to provide an aqueous solution that binds with surface materials to create a dust-free surface that resists particulate emission from traffic and does not erode after drying.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof

### BRIEF DESCRIPTION OF THE FIGURES

FIG. 1 is a flow diagram distributing an aqueous solution for use in dust control;

FIG. 2 is a view of the inline static mixer and nozzle; and

FIG. 3 is an exploded view of FIG. 2.

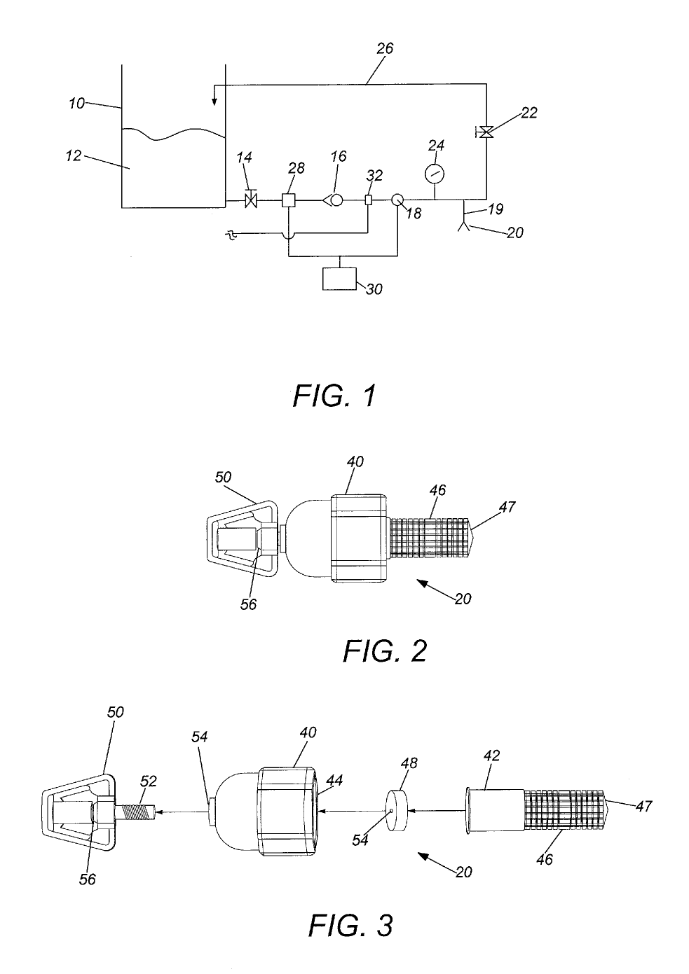

### DETAILED DESCRIPTION OF THE INVENTION

While a specific embodiment of the instant invention is disclosed herein, it is to be understood that the embodiment is merely exemplary of the invention, which may be embodied in various forms. Therefore, specific details disclosed herein are not to be interpreted as limiting, but merely as a basis for the claims and as representation basis for teaching one skilled in the art to variously employ the present invention in virtually any appropriately detailed system and method.

The aqueous solution of the instant invention is based upon a potassium based super absorbent polymer that is non-corrosive, nonflammable, non-toxic, and ecologically safe. The polymer is readily dilutable with water and is characterized as a fine powder before admixing with water to form the aqueous solution. Furthermore, the polymer is capable of being pushed through a hole less than 1 mm by 1 mm by use of pressurized as water wherein the water saturates the material upon contact. The aqueous solution according to the present invention provides an excavated material conveyor belt a means for controlling the dust that otherwise accumulates.

The polymer is admixed prior with water prior to dispersement or during contact with the excavated material as will be explained in more detail. In the most basic operation, a holding tank 10 is used for placement of an aqueous solution 12 consisting of ratio of about 0.75 lbs of dry potassium based polymer that is filtered to a particle size less than about 20 microns for each 100 gallons of water. The storage tank 10 has a shut off valve 14 and a check valve 16 to prevent back flow. A pump 18 is capable of providing at least 30 psi at a flow rate dependent upon the speed of the conveyor and the amount of coverage desired. The pump 18 is constructed and arranged to forcibly displace a volume of aqueous solution through the system to allow mixing. In the preferred embodiment the flow rate to each flow dispersing nozzle 20 is about 10 gph and controlled by the . Depending upon the pump employed and the operational period of the strip mind, a pressure relief valve 22 can be employed to control the pressure 24 to the dispensing nozzle 20. The pump can be sized to cause recirculation of the aqueous solution through a return pipe 26 to keep the aqueous solution from separating. A normally opened solenoid valve 28 is electrical coupled to the pump 18 wherein a controller is used to operate the pump and solenoid valve in conjunction with the operation of the conveyor belt.

An injection fitting is provided for use in cleaning of the lines should the system be disengaged for any length of time to fix or prevent clogging of the lines. The injection fitting can be coupled to a pressurized air source, or to pressurized water source, for use in flushing of the system lines. Variations on the placement of the injection fitting can be made in accordance with the operating parameters of the system. If the system is operated on a near continuous basis, the necessity of the injection system is negated.

The dispersing nozzle 20 has an opening defined as a pin hole and is used to direct the aqueous solution to the excavated material by use of a conventional spray fan configuration. The dispersing nozzle 20 is mounted to an endcap structure 40 having an inline static mixer 42 coupled along an intake 44. The inline static mixer 42 includes a passage end 46 that resembles a screen mesh and is formed of a hollow conduit having a wall surface formed from a mesh material having a spacing of less than 1 mm×1 mm and a sealed end 47. The aqueous solution is urgingly moved through the inline mixer where shearing effect takes place to assure polymer materials are fully saturated and of a sized to allow dispersement thought a conventional spray nozzle. The pressure of the pump or gravity shall force the fine potassium polymer through the inline static mixer 20 preventing clogging.

A flow distributor 48 is placed within the inline static mixer 42 to regulate the flow rate to about 10 gph but also serves to concentrate the flow of the aqueous solution after the mesh material to further ensure a wetting of the material and sizing that will pass through the spray nozzle 50. The flow distributor 48 employs a centered pin-sized hole 54 where the aqueous solution must pass therethrough. An outer surface of the flow distributor 48 sealingly engages an inner wall of the static mixer 42. The inline static mixer 42 is positioned between the dispersing nozzle 20 and the delivery line 19. The spray nozzle 50 has a male threaded end 52 which engages a receptacle 54 on the endcap structure 40. A directional fan 56 provides a fine misting of the aqueous solution over a moving conveyor belt, the misting of aqueous solution provides for immediate attachment to any airborne dust to force, or attachment to dust found on the excavated materials to inhibit the dust from becoming airborne.

The composition is sprayed onto desired surfaces and requires minimal re-application requirements under desirable weather conditions. The formula may penetrate into surfaces to bind with surface materials to lower the dust and allow ease of rehydration. The composition suppresses dust so it lessens the tendency to be picked up and be carried away by wind. The use of the composition described herein prevents dust particles from accumulating in the surrounding environment and it is generally sprayed over the dusting material.

The aqueous solution as used herein is a combination of water and an absorbent polymer made from a fine particle powder blend that is potassium based cross linked, crosslinkable homopolymers, or copolymers with water binding groups having a particle size range of 1-300 microns. The particle size distribution in a dry state having a moisture content of about 2.2% is as follows:

32% on 300 micron

42% on 150 micron

22% on 45 micron; and

4% thru 45 micron.

The polymer does not gel in a similar manner to conventional acrylic polymers and is sheared into smaller sizes by use of the pressurized water in combination with the screen mesh and flow distributor. The polymer of the instant invention is essentially a dust in and of itself, larger particles are capable of being reduced to a fine particle size by use of the in-line mixer.

According to an aspect of the present invention, a stable dust control composition comprises: a mixture of superabsorbent polymer and water. It has been found that this polymer can be mixed at a rate of about of ratio of about 0.75 lbs of potassium based dry polymer to 100 gallons of water, a realistic example would translate into 15 pounds of potassium based dry polymer to 2000 gallons of water. The rate of application provides an effective and environmentally friendly dust control system and method of application that can be applied onto the excavated materials to stabilize the base surface. The composition is a water-dilutable formula that binds with surface materials to create a dust-free surface that resists particulate emission from traffic and does not erode after drying.

The aqueous solution stabilizes dust particles and create a longer-lasting dust free environment and thus reduces the number of reapplications. The need for retreating with a composition of the polymer may not be necessary as the polymer can be rehydrated by additional water, rain or dew. As such, use of the composition is cost-effective in reducing loss of excavated material to the atmosphere, as well as reducing labor normally required to maintain a conventional dust control program through sustainability. Further, the composition is inert and will not affect end use of the material any more than the current dust byproduct of such materials.

Although it is appreciated that the ratio may favor lower or higher amounts of the polymer as determined by the application, the actual determining factors may vary greatly including the relative humidity that might be present in the area. Alternatively there may be instances where higher levels of polymer may be applied to gravel piles, sand piles, slag piles and the like piles to keep windblown dust to a minimum.

The system and method may be used on a wide variety of applications for the purposes of dust control and surface stabilization. Typical application rates are about 1.5 L of diluted product per square meter. The conveyor system may be constructed and arranged for use on gravel, sand, dirt, mud, minerals, and virtually any other desired material. As a preventative dust maintenance measure, it is cost effective both in the short and with long term usage. The system is capable of dispersing a composition that penetrates and extends bonding into a surface, such as gravel, by providing cohesion, preventing sediment wash-out and increasing the load-bearing capacity of unpaved road surfaces. Furthermore, the composition as applied to a gravel bed for example, provides a reduction of aggregate loss, enhances conservation of native gravel, provides safety to motorists and delivers effective dust control.

### Example 1

Usually, for dust controlling solutions, the most preferred application method is spraying a mixture of the polymer and water over the excavated material in a quantity sufficient to cover the dust. Several solution concentrations were tested and it was found that the minimum polymer concentration to achieve an excellent dust suppression level is of about 15 pounds of polymer to 2000 gallons of water. In a tank holding multiples of 2,000 gallons of water, add 15 pounds of super absorbent polymer through the manhole for each 2,000 gallons. The polymer maintains the water for a much longer period of time by preventing the water from leaching into the ground, as well as controlling the amount of evaporation.

The dust control system of the instant invention is for use a continuous conveyor belt at a strip mine wherein the conveyor belt has an upper surface for use in the movement of excavated material and a lower surface supported by a plurality of roller supports. The treating of the dust not only makes for a tolerable environment, the equipment including the rollers require less maintenance by the reduction of the airborne grit.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A dust control system for use a continuous conveyor belt at a strip mine wherein the conveyor belt has an upper surface for use in the movement of excavated material and a lower surface supported by a plurality of roller supports, said dust control system comprising:
a tank constructed and arranged to hold an aqueous solution, said aqueous solution consisting of a predetermined ratio of a potassium based polymer and water;
a distribution pump having an intake fluidly coupled to said tank for receipt of said aqueous solution and a pump outtake for transferring of said aqueous solution at a pressure of about 30 psi;
an inline static mixer fluidly coupled to said pump outtake; and
at least one spray nozzle fluidly coupled to said inline mixer;
wherein said aqueous solution is distributed over the excavated material for dust control as the excavated material passes the spray nozzle as it is moved along the conveyor belt.

2. The dust control system according to claim 1 wherein said polymer is of a particle size of about: 32% on 300 micron, 42% on 150 micron, 22% on 45 micron and 4% thru 45 micron based on a dry state having a moisture content of about 2.2%.

3. The dust control system according to claim 1 including a normally closed electric solenoid positioned before said to control the flow of aqueous solution from said tank, said solenoid and said pump powered when the conveyor is moving.

4. The dust control system according to claim 1 wherein said inline static mixer includes a screen mesh having spacing for passage of said aqueous solution of less than 1 mm×1 mm.

5. The dust control system according to claim 1 wherein said inline static mixer includes a distributor capable of limiting of the flow rate of said aqueous solution.

6. The dust control system according to claim 5 wherein said flow rate is 10 gph.

7. The dust control system according to claim 1 including a pressure relief valve to control the pressure to the dispensing nozzle and recirculate the aqueous solution to said tank for keep the aqueous solution from separating.

8. A dust control system for use a continuous conveyor belt at a strip mine wherein the conveyor belt has an upper surface for use in the movement of excavated material and a lower surface supported by a plurality of roller supports, said dust control system comprising:
a tank constructed and arranged to hold an aqueous solution, said aqueous solution consisting of a potassium based polymer having a particle size of about: 32% on 300 micron, 42% on 150 micron, 22% on 45 micron and 4% thru 45 micron based on a dry state having a moisture content of about 2.2% admixed with water;
a distribution pump having an intake fluidly coupled to said tank for receipt of said aqueous solution and a pump outtake for transferring of said aqueous solution at a pressure of about 30 psi;
an inline static mixer fluidly coupled to said pump outtake, said mixer including a screen mesh having spacing for passage of said aqueous solution of less than 1 mm×1 mm; and
at least one spray nozzle fluidly coupled to said inline mixer;
wherein said aqueous solution is distributed over the excavated material for dust control as the excavated material passes the spray nozzle as it is moved along the conveyor belt.

9. The dust control system according to claim 8 including a normally closed electric solenoid positioned before said to control the flow of aqueous solution from said tank, said solenoid and said pump powered when the conveyor is moving.

10. The dust control system according to claim 8 wherein said inline static mixer includes a distributor capable of limiting of the flow rate of said aqueous solution.

11. The dust control system according to claim 10 wherein said flow rate is 10 gph.

12. The dust control system according to claim 8 including a pressure relief valve to control the pressure to the dispensing nozzle and recirculate the aqueous solution to said tank for keep the aqueous solution from separating.
